(19) United States
(12) Patent Application Publication
(10) Pub. No.: US 2025/0232918 A1
(43) Pub. Date: Jul. 17, 2025

(54) PARTIALLY ENCAPSULATED DC LINK CAPACITOR MODULE AND VOLTAGE CONVERTER

(71) Applicant: VALEO ELECTRIFICATION, Cergy (FR)

(72) Inventors: Lothar SEIF, Cergy Pontoise (FR); Christophe LOPES, Cergy Pontoise (FR); Aurélien POUILLY, Cergy Pontoise (FR)

(73) Assignee: VALEO ELECTRIFICATION, Cergy (FR)

(21) Appl. No.: 18/874,246

(22) PCT Filed: Jun. 14, 2023
(86) PCT No.: PCT/EP2023/066005

§ 371 Date: Dec. 12, 2024

(30) Foreign Application Priority Data
Jun. 15, 2022 (FR) FR2205840

(51) Int. Cl. H01G 4/224; H01G 4/228; H01G 4/40

(52) U.S. Cl. CPC H01G 4/224; H01G 4/228; H01G 4/40

(57) ABSTRACT

A DC link capacitor module includes at least one capacitor cell having a capacitor element, a housing forming a cup, the at least one capacitor cell being at least partially pushed into the cup. A fluidtight cover includes an end wall and a peripheral wall, and covers the capacitor element. A protective resin is poured into the cup, wherein a first part of the at least one capacitor cell is immersed in the protective resin over a first height and a second part of the at least one capacitor cell, distinct from the first part, is out of the protective resin over a second height. The peripheral wall includes an uninterrupted end zone that is immersed in the protective resin over a third height so that the second part of the at least one capacitor cell is protected in a fluidtight manner by the fluidtight cover.

The invention relates to a DC link capacitor module and to a voltage converter, in particular an inverter, comprising such a DC link capacitor module. The invention also relates to a method of manufacture for such a DC link capacitor module.

A voltage converter, in particular inverters, comprises a DC link capacitor module for filtering a DC voltage supplied by a DC voltage source.

Patent application US20140286064A1 discloses a DC link capacitor module comprising:
a capacitor cell comprising a capacitor element comprising a first metallized film and a second metallized film wound together; and a first contact terminal connected to the first metallized film and a second contact terminal connected to the second metallized film,
a housing forming a cup, the at least one capacitor cell being completely immersed in the cup,
a protective resin that is cast in the cup and completely covers the at least one capacitor cell.

Such a DC link capacitor module has the drawback of requiring the use of a large amount of resin.

Since the cost of the resin and of its implementation is high, the cost of the DC link capacitor module is also high.

The present invention seeks to overcome all or some of these drawbacks.

The invention relates to a DC link capacitor module comprising:
at least one capacitor cell comprising a capacitor element, a first contact terminal and a second contact terminal,
a housing forming a cup, the at least one capacitor cell being at least partially immersed in the cup,
a fluidtight cover comprising a bottom and a peripheral wall, the fluidtight cover covering the capacitor element,
a protective resin, in particular an epoxy resin, that is cast in the cup,
   wherein a first portion of the at least one capacitor cell is submerged in the protective resin to a first height and a second portion of the at least one capacitor cell, which is separate from the first portion, is out of the protective resin to a second height, and
   the peripheral wall comprises an uninterrupted end region that is submerged in the protective resin to a third height so that the second portion of the at least one capacitor cell is protected in a fluidtight manner by the fluidtight cover.

Such a DC link capacitor module allows the amount of protective resin used to be reduced while ensuring good protection of the capacitor cell. Moreover, such a reduced amount of resin reduces the time necessary for polymerizing the resin. Thus, the cost of the DC link capacitor is reduced.

According to an additional feature of the invention, the first contact terminal and the second contact terminal have a first contact end and a second contact end, respectively, the first contact end and the second contact end being out of the resin so as to be able to be electrically connected to a plurality of controllable switches of a power electronics module.

According to an additional feature of the invention, a positioning relief is formed in the housing, the relief being in contact with a guide portion formed in the peripheral edge.

Such a positioning relief and such a guide portion allow precise positioning of the fluidtight cover in the housing. Thus, the manufacture of the DC link capacitor module is simplified.

According to an additional feature of the invention, the guide portion is formed in the uninterrupted end region of the peripheral wall.

According to an additional feature of the invention, a form-fit, in particular snap-fit, connection is made between the at least one capacitor cell and the fluidtight cover.

Such a form-fit connection allows, for example, the fluidtight cover and the capacitor cell to be assembled before they are positioned in the cup formed by the housing. Since a single subassembly is manipulated during this positioning, manufacture is simplified. The use of this form-fit connection along with the positioning reliefs and guide portion described above allows even simpler manufacture by allowing the fluidtight cover and the capacitor cell to be positioned in the housing at the same time. According to an additional feature of the invention, the uninterrupted end region comprises at least one aperture so as to allow resin to be present inside the fluidtight cover as far as the level of the aperture.

Such an aperture allows a portion of the protective resin to be introduced inside the fluidtight cover to a portion of the third height that is not zero and strictly less than the third height. Thus, the holding of the fluidtight cover in the protective resin is improved.

According to an additional feature of the invention, the at least one capacitor cell is in thermal contact with a first inner surface of the bottom of the fluidtight cover via a first thermally conductive block, in particular a thermal interface material, for example a thermal paste or thermal pad.

Such thermal contact via a thermal block improves the cooling of the capacitor cell. Thus, the reliability of the DC link capacitor module is improved.

According to an additional feature of the invention, a first outer surface of the bottom of the fluidtight cover, opposite the first inner surface of the bottom of the fluidtight cover, has first cooling fins.

Such cooling fins improve the cooling of the capacitor cell.

According to an additional feature of the invention, the bottom of the fluidtight cover is at least partially metallic, in particular the first cooling fins, and the first thermally conductive block is an electrical insulator.

According to an additional feature of the invention, the capacitor element comprises a first metallized film and a second metallized film wound together, the first contact terminal being connected to the first metallized film and the second contact terminal being connected to the second metallized film.

According to an additional feature of the invention, the DC link capacitor module comprises a plurality of capacitor cells.

The invention also relates to a voltage converter, in particular an inverter, comprising a DC link capacitor module as described above and a power module comprising a plurality of controllable switches electrically connected to the first contact terminal and the second contact terminal.

According to an additional feature of the invention, the voltage converter comprises a casing, the housing being integrally formed in the casing.

The invention also relates to a method of manufacture for a DC link capacitor module as described above, comprising the following steps:
a first step of providing at least one capacitor cell comprising a capacitor element, a first contact terminal and a second contact terminal,
a second step of providing a housing forming a cup,
a third step of providing a fluidtight cover comprising a bottom and a peripheral wall,
a step of positioning the at least one capacitor cell in the cup so that the at least one capacitor cell is at least partially immersed in the cup,
a step of mounting the fluidtight cover on the capacitor element so that the fluidtight cover covers the capacitor element,
a step of holding the fluidtight cover in position,
during the step of holding the fluidtight cover in position, a step of pouring a protective resin, in particular an epoxy resin, into the cup so as to submerge a first portion of the at least one capacitor cell in the protective resin to a first height and so as to leave a second portion of the at least one capacitor cell out of the protective resin to a second height and so that an uninterrupted end region of the peripheral wall is submerged in the protective resin to a third height,
following the pouring step, a step of polymerizing the protective resin.

According to an additional feature of the invention, the method of manufacture for a DC link capacitor module comprises a step of depressurizing relative to atmospheric pressure before the pouring step and a step of reducing the depressurization, in particular of establishing atmospheric pressure, after the pouring step but before the polymerization step.

Such a depressurization step and such a step of reducing the depressurization allow the amount of protective resin getting inside the fluidtight cover to be increased. This increased amount of protective resin inside the fluidtight cover means that the fixing of the cover and the fixing of the capacitor coll by the resin are improved.

According to an additional feature of the invention, the method of manufacture for a DC link capacitor module comprises a step of pressurizing relative to atmospheric pressure after the pouring stop and a step of reducing the overpressure, in particular of establishing atmospheric pressure, after the polymerization step.

Such a pressurization step and such a step of reducing the overpressure allow the amount of protective resin getting inside the fluidtight cover to be increased. This increased amount of protective resin inside the fluidtight cover means that the fixing of the cover and the fixing of the capacitor cell by the resin are improved. Moreover, after the step of reducing the overpressure, the pressure inside the fluidtight cover remains high, substantially at the level at which it was during the pressurization step. This high pressure inside the cover allows a possible problem of diffusion of gas from the outside of the fluidtight cover to the inside of the fluidtight cover to be limited or even eliminated. The inside of the fluidtight cover is thus protected from pollution coming from the outside of the fluidtight cover.

In all of the above, the rotor may comprise any number of pairs of poles, for example six or eight pairs of poles.

In all of the above, the rotating electrical machine may have a stator having a polyphase electrical winding, for example formed by wires or by conducting bars connected to one another.

The rotating electrical machine may comprise a power electronics component that is able to be connected to the electrical system of a vehicle. This power electronics component comprises for example an inverter/rectifier that allows an electrical system of the vehicle to be charged or that can be powered from this system, depending on whether the rotating electrical machine is operating as a motor or as a generator.

The invention may be understood better upon reading the following description of non-limiting exemplary implementations thereof and upon studying the appended drawing, in which:

FIG. 1 shows a circuit diagram of a voltage converter electrical assembly according to the invention,

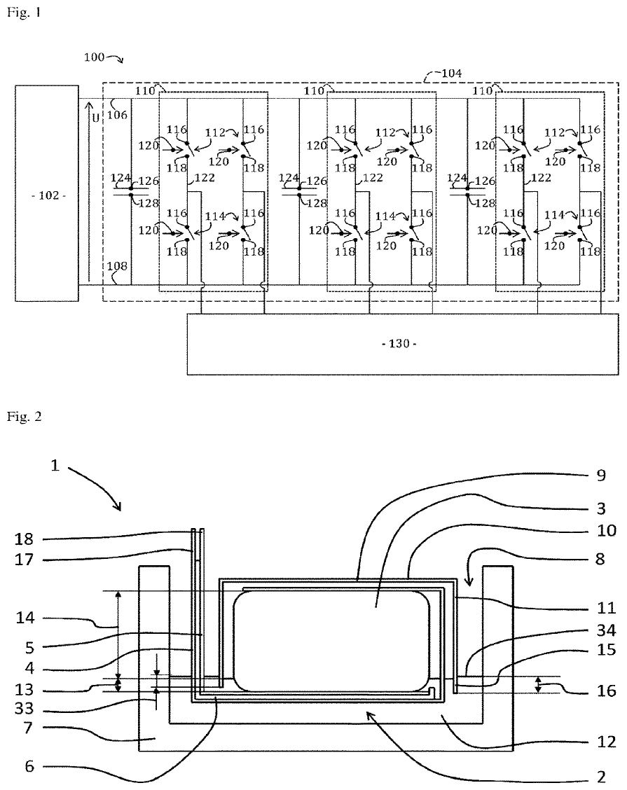

FIG. 2 shows a partial schematic sectional view of a DC link capacitor module according to a first embodiment,

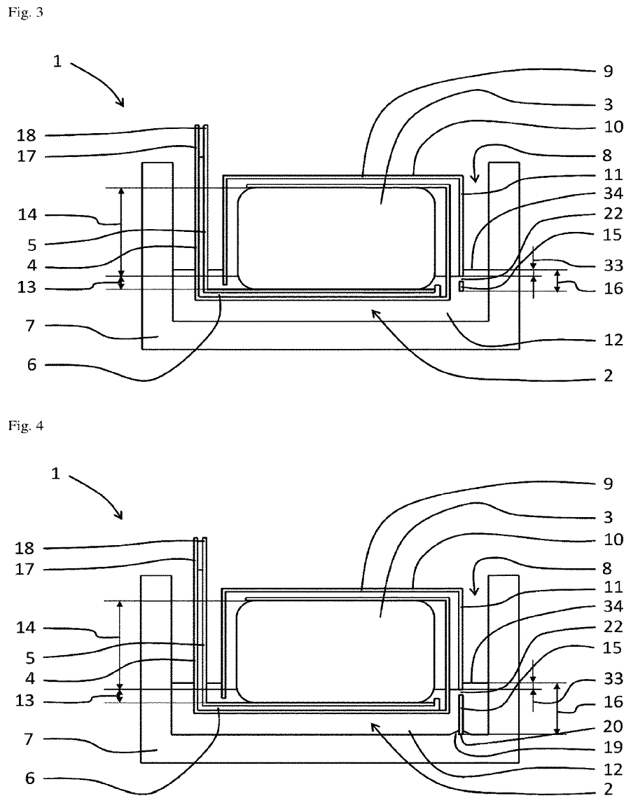

FIG. 3 shows a partial schematic sectional view of a DC link capacitor module according to a second embodiment,

FIG. 4 shows a partial schematic sectional view of a DC link capacitor module according to a third embodiment,

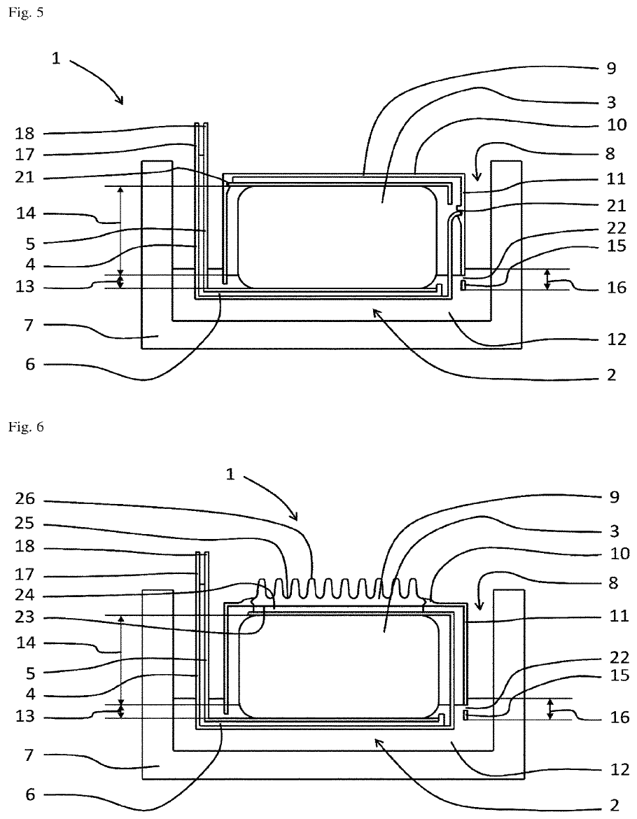

FIG. 5 shows a partial schematic sectional view of a DC link capacitor module according to a fourth embodiment,

FIG. 6 shows a partial schematic sectional view of a DC link capacitor module according to a fifth embodiment,

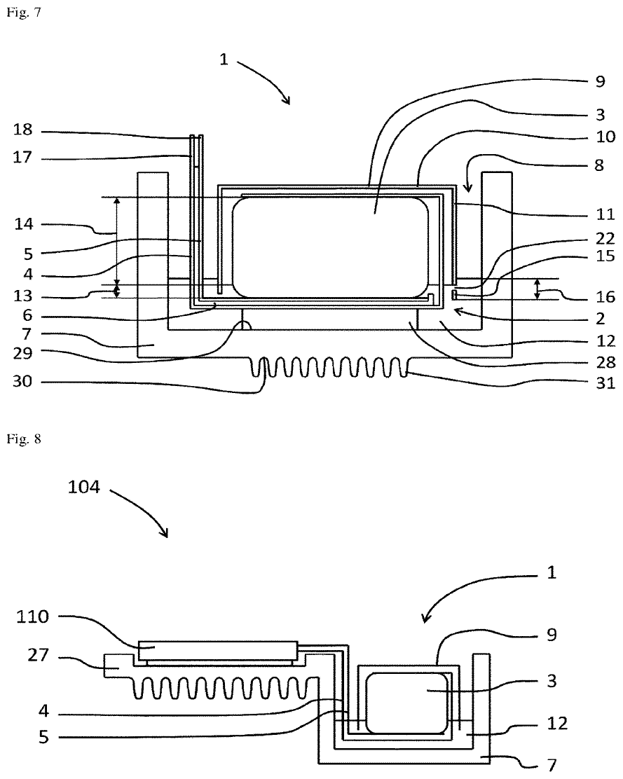

FIG. 7 shows a partial schematic sectional view of a DC link capacitor module according to a sixth embodiment,

FIG. 8 shows a partial schematic sectional view of a voltage converter according to the invention,

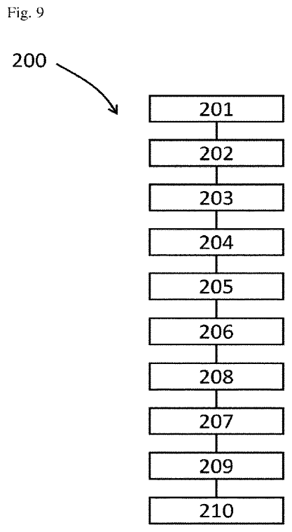

FIG. 9 shows a flowchart of the various steps of a first variant of a method of manufacture for a DC link capacitor module according to the invention,

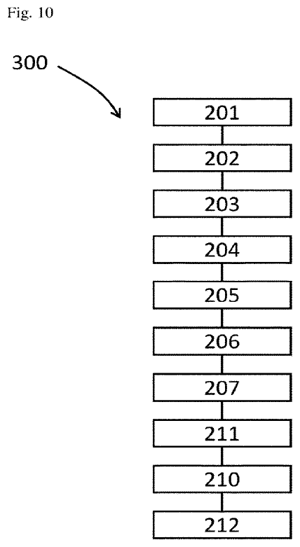

FIG. 10 shows a flowchart of the various steps of a second variant of a method of manufacture for a DC link capacitor module according to the invention.

Throughout the figures, elements that are identical or perform the same function bear the same reference numerals. The embodiments that follow are examples. Although the description refers to one or more embodiments, this does not necessarily mean that each reference relates to the same embodiment, or that the features apply only to one embodiment. Individual features of different embodiments can also be combined or interchanged in order to provide other embodiments.

Ordinal numeral adjectives are used to distinguish between features. They do not define the position of a feature. Consequently, for example, a third feature of a product does not mean that the product has a first and/or a second feature.

FIG. 1 shows an electrical assembly 100 in which the invention may be implemented.

The electrical assembly 100 is intended to be installed in a motor vehicle, for example.

The electrical assembly 100 firstly comprises a power source 102 designed to deliver a DC voltage U.

The power source 102 comprises a battery, for example.

The electrical assembly 100 furthermore comprises a rotating electrical machine 130 comprising multiple phase windings (not shown) that are intended to have respective phase voltages.

The electrical assembly 100 furthermore comprises an electronic system 104.

In the various embodiments shown in the figures, the electronic system 104 is a voltage converter 104. However, in other embodiments (not shown), the assembly may perform a different function. The voltage converter 104 is connected between the power source 102 and the rotating electrical machine 130 in order to perform a conversion between the DC voltage U and the phase voltages.

The voltage converter 104 firstly comprises a positive electric line 106 and a negative electric line 108 that are intended to be connected to the power source 102 in order to receive the DC voltage U, the positive electric line 106 receiving a high electrical potential and the negative electric line 108 receiving a low electrical potential.

The voltage converter 104 furthermore comprises at least one power electronics module 110 comprising one or more phase electric lines 122 that are intended to be respectively connected to one or more phases of the rotating electrical machine 130 in order to provide their respective phase voltages.

In the example described, the voltage converter 104 comprises three power electronics modules 110, each comprising two phase electric lines 122 connected to two phases of the electrical machine 130.

More specifically, in the example described, the electrical machine 130 has two three-phase systems having three phases each and intended to be electrically phase-shifted by 120° with respect to one another. Preferably, the first phase electric lines 122 of the power electronics modules 110 are respectively connected to the three phases of the first three-phase system, whereas the second phase electric lines 122 of the power electronics modules 110 are respectively connected to the three phases of the second three-phase system.

Each power electronics module 110 comprises, for each phase electric line 122, a first controllable switch 112 connected between the positive electric line 106 and the phase electric line 122 and a second controllable switch 114 connected between the phase electric line 122 and the negative electric line 108. Thus, the controllable switches 112, 114 are arranged so as to form a chopping arm, in which the phase electric line 122 forms a center tap.

Each controllable switch 112, 114 comprises first and second main terminals 116, 118 and a control terminal 120 that is intended to selectively open and close the controllable switch 112, 114 between its two main terminals 116, 118 depending on a control signal that is applied to said control terminal. The controllable switches 112, 114 are preferably transistors, for example insulated gate bipolar transistors (IGBTs) having a gate forming the control terminal 120, and a drain and a source forming the main terminals 116, 118, respectively.

For example, the controllable switches 112, 114 each have the form of a plate, which is substantially rectangular, for example, having an upper face and a lower face. The first main terminal 116 extends over the lower face, whereas the second main terminal 118 extends over the upper face. Furthermore, the lower face forms a heat dissipation surface.

The voltage converter 104 furthermore comprises a filtering capacitor 124 having a first terminal 126 and a second terminal 128 that are connected to the positive electric line 106 and to the negative electric line 108, respectively. In the voltage converter of FIG. 1, a filtering capacitor 124 is associated with each power electronics module 110. In another embodiment of the invention (not shown), the filtering capacitor is associated with multiple power electronics modules.

FIG. 2 shows a partial schematic sectional view of a DC link capacitor module 1 according to a first embodiment. The DC link capacitor module 1 comprises:
at least one capacitor cell 2 comprising a capacitor element 3, a first contact terminal 4 and a second contact terminal 5,
a housing 7 forming a cup 8, the at least one capacitor cell 2 being at least partially immersed in the cup 8,
a fluidtight cover 9 comprising a bottom 10 and a peripheral wall 11, the fluidtight cover 9 covering the capacitor element 3,
a protective resin 12, in particular an epoxy resin, that is cast in the cup 8.

A first portion of the at least one capacitor cell 2 is submerged in the protective resin 12 to a first height 13. A second portion of the at least one capacitor cell 2, which is separate from the first portion, is out of the protective resin 12 to a second height 14. The peripheral wall 11 comprises an uninterrupted end region 15 that is submerged in the protective resin 12 to a third height 16 so that the second portion of the at least one capacitor cell 2 is protected in a fluidtight manner by the fluidtight cover 9. The uninterrupted end region 15 is uninterrupted in that the protective resin 12 is in contact with the peripheral wall 11 to a fourth, non-zero height 33 from the surface 34 of the protective resin 12.

The first contact terminal 4 and the second contact terminal 5 are for example electrically connected to the positive electrical line 106 and to the negative electrical line 108, respectively. For example, the DC link capacitor module 1 performs the function of the filtering capacitor 124.

The first contact terminal 4 and the second contact terminal 5 may have a first contact end 17 and a second contact end 18, respectively. The first contact end 17 and the second contact end 18 are, for example, outside the resin so as to be able to be electrically connected to a plurality of controllable switches 112, 114 of a power electronics module 110. For example, the first contact end 17 and the second contact end 18 are soldered to a first busbar and a second busbar, respectively, of the power electronics module 110.

FIG. 3 shows a partial schematic sectional view of a DC link capacitor module 1 according to a second embodiment. In the second embodiment, the uninterrupted end region 15 comprises at least one aperture 22 so as to allow resin to be present inside the fluidtight cover as far as the level of the aperture 22. As in the first embodiment, the uninterrupted end region 15 is uninterrupted in that the protective resin 12 is in contact with the peripheral wall 11 to a non-zero depth from the surface of the protective resin 12. The uninterrupted end region 15 is, for example, uninterrupted to a fourth height 33 between the aperture 22 and the surface 34 of the protective resin 12.

In another embodiment (not shown) of the invention, the uninterrupted end region comprises at least one aperture in a crenelate shape so as to allow resin to be present inside the fluidtight cover as far as the bottom of the crenelate shape.

FIG. 4 shows a partial schematic sectional view of a DC link capacitor module 1 according to a third embodiment of the invention. The third embodiment of the invention is similar to the first and second embodiments of the invention. In the third embodiment of the invention, a positioning relief 19 is formed in the housing 7, the relief being in contact with a guide portion 20 formed in the peripheral edge 11. For example, the positioning relief 19 comprises a cavity and the guide portion 20 comprises a tenon, the tenon entering the cavity.

In a variant (not shown) of the third embodiment of the invention, the guide portion is held in the relief, for example by virtue of a snap-fit connection.

In a variant (not shown) of the third embodiment of the invention, multiple positioning reliefs are formed in the housing, each positioning relief being in contact with a guide portion formed in the peripheral edge.

For example, the guide portion 20 is formed in the uninterrupted end region 15 of the peripheral wall 11.

FIG. 5 shows a partial schematic sectional view of a DC link capacitor module 1 according to a fourth embodiment of the invention. The fourth embodiment of the invention is similar to the embodiments of the invention described above. In the fourth embodiment of the invention, a form-fit connection 21 is made between the at least one capacitor cell 3 and the fluidtight cover 9. For example, the form-fit connection 21 is a snap-fit connection. For example, the snap-fit connection is made between the first contact terminal 4 and the fluidtight cover 9. In the embodiment shown in FIG. 5, two form-fit connections 21 are made. For example, the snap-fit connection is made by virtue of a tab formed in the first contact terminal 4 entering a notch formed in the fluidtight cover 9. In a variant embodiment (not shown) of the invention, a form-fit, in particular snap-fit, connection is made between the second contact terminal and the fluidtight cover.

In a variant embodiment (not shown) of the invention, a form-fit, in particular snap-fit, connection is made between the first contact terminal and the fluidtight cover and a form-fit, in particular snap-fit, connection is made between the second contact terminal and the fluidtight cover.

FIG. 6 shows a partial schematic sectional view of a DC link capacitor module 1 according to a fifth embodiment of the invention. The fifth embodiment of the invention is similar to the embodiments of the invention described above. In the fifth embodiment of the invention, the at least one capacitor cell 2 is in thermal contact with a first inner surface 23 of the bottom 10 of the fluidtight cover 9 via a first thermally conductive block 24. For example, the first thermally conductive block 24 is a thermal interface material (TIM), in particular a thermal paste or thermal pad.

For example, a first outer surface 25 of the bottom of the fluidtight cover 9, opposite the first inner surface 23 of the bottom 10 of the fluidtight cover 9, has first cooling fins 26.

For example, the bottom 10 of the fluidtight cover 9 is at least partially metallic and the first thermally conductive block 24 is an electrical insulator, for example. For example, the first cooling fins 26 are metallic, in particular made of aluminum. For example, the fluidtight cover 9 comprises a non-metallic portion, in particular made of plastic. For example, the metal portion of the bottom 10 of the fluidtight cover 9 is overmoulded in the non-metallic portion.

In another embodiment (not shown) of the invention, the first cooling fins are made from a thermally conductive plastic material, for example a plastic material with a filler, for example a metallic filler, in particular a silver (Ag) filler.

In another embodiment (not shown) of the invention, the fluidtight cover is made entirely from a thermally conductive plastic material, for example a plastic material with a filler, for example a metallic filler, in particular a silver (Ag) filler. For example, a first outer surface of the bottom of the fluidtight cover, opposite the first inner surface of the bottom of the fluidtight cover, has first cooling fins.

FIG. 7 shows a partial schematic sectional view of a DC link capacitor module 1 according to a sixth embodiment of the invention. The sixth embodiment of the invention is similar to the embodiments of the invention described above. In the sixth embodiment of the invention, the at least one capacitor cell 2 is in thermal contact with a second inner surface 29 of the housing 7 via a second thermally conductive block 28. For example, the second thermally conductive block 28 is a thermal interface material, in particular a thermal paste or thermal pad.

For example, a second outer surface 30 of the housing 7, opposite the second inner surface 29 of the housing 7, has second cooling fins 31. For example, the housing 7 is metallic, in particular made of aluminum. In another example, the housing 7 is made from a thermally conductive plastic material, for example a plastic material with a filler, for example a metallic filler, in particular a silver (Ag) filler.

In the various embodiments of the invention, the capacitor element 3 may comprise a first metallized film and a second metallized film wound together. The first contact terminal 4 is for example connected to the first metallized film and the second contact terminal 5 is for example connected to the second metallized film.

In another embodiment of the invention, the capacitor element 3 is of ceramic, tantalum, electrolytic or polymeric type.

The DC link capacitor module 1 may comprise a plurality of capacitor cells 2.

FIG. 8 shows a partial schematic sectional view of the voltage converter 104 according to the invention. The voltage converter 104 comprises a DC link capacitor module 1 and a power module 110 comprising a plurality of controllable switches 112, 114 electrically connected to the first contact terminal 4 and the second contact terminal 5.

The voltage converter 104 may also comprise a casing 27. The housing 7 is, for example, integrally formed in the casing 27.

FIG. 9 shows a flowchart of the various steps of a first variant of a method of manufacture 200 for the DC link capacitor module according to the invention. The method of manufacture 200 comprises the following steps:
a first step of providing 201 at least one capacitor cell 2 comprising a capacitor element 3, a first contact terminal 4 and a second contact terminal 5,
a second step of providing 202 a housing 7 forming a cup 8,
a third step of providing 203 a fluidtight cover 9 comprising a bottom 10 and a peripheral wall 11,
a step of positioning 204 the at least one capacitor cell 2 in the cup so that the at least one capacitor cell 2 is at least partially immersed in the cup 8,
a step of mounting 205 the fluidtight cover 9 on the capacitor element 3 so that the fluidtight cover 9 covers the capacitor element,
a stop of holding the fluidtight cover 9 in position 206,
during the step of holding the fluidtight cover 9 in position 206, a step of pouring 207 a protective resin 12, in particular an epoxy resin, into the cup 8 so as to submerge a first portion of the at least one capacitor cell 2 in the protective resin 12 to a first height 13 and so as to leave a second portion of the at least one capacitor cell 2 out of the protective resin 12 to a second height 14 and so that an uninterrupted end region 15 of the peripheral wall 11 is submerged in the protective resin 12 to a third height 16,
following the pouring step 207, a step of polymerizing 210 the protective resin 12.

As seen above, the uninterrupted end region 15 is uninterrupted in that the protective resin 12 is in contact with the peripheral wall 11 to a fourth, non-zero height 33 from the surface 34 of the protective resin 12.

For example, the holding in position step 206 is carried out by virtue of a prior fixing step, for example screwing or snap-fitting the cover 9, in particular screwing or snap-fitting the cover 9 onto the housing 7. In another example, the holding in position step 206 is carried out using a hold-in-position tool, in particular a robot manipulator arm.

The first variant of the method 200 may furthermore comprise a step of depressurizing 208 relative to atmospheric pressure before the pouring step 207 and a step of reducing the depressurization 209, in particular of establishing atmospheric pressure, after the pouring step 207 but before the polymerization step 210.

FIG. 10 shows a flowchart of the various steps of a second variant of a method of manufacture 300 for the DC link capacitor module according to the invention. The second variant of the method 300 is similar to the first variant of the method 200. However, the second variant of the method 300 comprises a step of pressurizing 211 relative to atmospheric pressure after the pouring step 207 and a step of reducing overpressure 212, in particular of establishing atmospheric pressure, after the polymerization step 210.

1. A DC link capacitor module comprising:
a. at least one capacitor cell comprising a capacitor element, a first contact terminal and a second contact terminal,
b. a housing forming a cup, the at least one capacitor cell being at least partially immersed in the cup,
c. a fluidtight cover comprising a bottom and a peripheral wall, the fluidtight cover covering the capacitor element,
d. a protective resin, in particular an epoxy resin, that is cast in the cup,
wherein a first portion of the at least one capacitor cell is submerged in the protective resin to a first height and a second portion of the at least one capacitor cell, which is separate from the first portion, is out of the protective resin to a second height, and
the peripheral wall comprises an uninterrupted end region that is submerged in the protective resin to a third height so that the second portion of the at least one capacitor cell is protected in a fluidtight manner by the fluidtight cover.

2. The DC link capacitor module as claimed in claim 1, wherein the first contact terminal and the second contact terminal have a first contact end and a second contact end, respectively, the first contact end and the second contact end being out of the resin so as to be able to be electrically connected to a plurality of controllable switches of a power electronics module.

3. The DC link capacitor module as claimed in claim 1, wherein a positioning relief is formed in the housing, the relief being in contact with a guide portion formed in the peripheral edge.

4. The DC link capacitor module as claimed in claim 3, wherein the guide portion is formed in the uninterrupted end region of the peripheral wall.

5. The DC link capacitor module as claimed in claim 1, wherein a form-fit, in particular snap-fit, connection is made between the at least one capacitor cell and the fluidtight cover.

6. The DC link capacitor module as claimed in claim 1, wherein the uninterrupted end region comprises at least one aperture so as to allow resin to be present inside the fluidtight cover as far as the level of the aperture.

7. The DC link capacitor module as claimed in claim 1, wherein the at least one capacitor cell is in thermal contact with a first inner surface of the bottom of the fluidtight cover via a first thermally conductive block, in particular a thermal interface material, for example a thermal paste or thermal pad.

8. The DC link capacitor module as claimed in claim 7, wherein a first outer surface of the bottom of the fluidtight cover, opposite the first inner surface of the bottom of the fluidtight cover, has first cooling fins.

9. The DC link capacitor module as claimed in claim 8, wherein the bottom of the fluidtight cover is at least partially metallic, in particular the first cooling fins, and the first thermally conductive block is an electrical insulator.

10. A voltage converter, in particular an inverter, comprising a DC link capacitor module as claimed in claim 1 and a power module comprising a plurality of controllable switches electrically connected to the first contact terminal and the second contact terminal, in particular the voltage converter comprises a casing, the housing being integrally formed in the casing.

11. A method of manufacture for a DC link capacitor module as claimed in claim 1, comprising the following steps:
a. a first step of providing at least one capacitor cell comprising a capacitor element, a first contact terminal and a second contact terminal,
b. a second step of providing a housing forming a cup,
c. a third step of providing a fluidtight cover comprising a bottom and a peripheral wall,
d. a step of positioning the at least one capacitor cell in the cup so that the at least one capacitor cell is at least partially immersed in the cup,
e. a step of mounting the fluidtight cover on the capacitor element so that the fluidtight cover covers the capacitor element,
f. a step of holding the fluidtight cover in position,
g. during the step of holding the fluidtight cover in position, a step of pouring a protective resin, in particular an epoxy resin, into the cup so as to submerge a first portion of the at least one capacitor cell in the protective resin to a first height and so as to leave a second portion of the at least one capacitor cell out of the protective resin to a second height and so that an uninterrupted end region of the peripheral wall is submerged in the protective resin to a third height,
h. following the pouring step, a step of polymerizing the protective resin.

12. The method of manufacture as claimed in claim 11, comprising a step of depressurizing relative to atmospheric pressure before the pouring step and a step of reducing the depressurization, in particular of establishing atmospheric pressure, after the pouring step but before the polymerization step.

13. The method of manufacture as claimed in claim 11, comprising a step of pressurizing relative to atmospheric pressure after the pouring step and a step of reducing overpressure, in particular of establishing atmospheric pressure, after the polymerization step.

14. The DC link capacitor module as claimed in claim 2, wherein a positioning relief is formed in the housing, the relief being in contact with a guide portion formed in the peripheral edge.

15. The DC link capacitor module as claimed in claim 2, wherein a form-fit, in particular snap-fit, connection is made between the at least one capacitor cell and the fluidtight cover.

16. The DC link capacitor module as claimed in claim 2, wherein the uninterrupted end region comprises at least one aperture so as to allow resin to be present inside the fluidtight cover as far as the level of the aperture.

17. The DC link capacitor module as claimed in claim 2, wherein the at least one capacitor cell is in thermal contact with a first inner surface of the bottom of the fluidtight cover via a first thermally conductive block, in particular a thermal interface material, for example a thermal paste or thermal pad.

18. A voltage converter, in particular an inverter, comprising a DC link capacitor module as claimed in claim 2 and a power module comprising a plurality of controllable switches electrically connected to the first contact terminal and the second contact terminal, in particular the voltage converter comprises a casing, the housing being integrally formed in the casing.

19. A method of manufacture for a DC link capacitor module as claimed in claim 2, comprising the following steps:
a. a first step of providing at least one capacitor cell comprising a capacitor element, a first contact terminal and a second contact terminal,
b. a second step of providing a housing forming a cup,
c. a third step of providing a fluidtight cover comprising a bottom and a peripheral wall,
d. a step of positioning the at least one capacitor cell in the cup so that the at least one capacitor cell is at least partially immersed in the cup,
e. a step of mounting the fluidtight cover on the capacitor element so that the fluidtight cover covers the capacitor element,
f. a step of holding the fluidtight cover in position,
g. during the step of holding the fluidtight cover in position, a step of pouring a protective resin, in particular an epoxy resin, into the cup so as to submerge a first portion of the at least one capacitor cell in the protective resin to a first height and so as to leave a second portion of the at least one capacitor cell out of the protective resin to a second height and so that an uninterrupted end region of the peripheral wall is submerged in the protective resin to a third height,
h. following the pouring step, a step of polymerizing the protective resin.

20. The DC link capacitor module as claimed in claim 3, wherein a form-fit, in particular snap-fit, connection is made between the at least one capacitor cell and the fluidtight cover.
